(19) United States
(12) Patent Application Publication
(10) Pub. No.: US 2012/0000218 A1
(43) Pub. Date: Jan. 5, 2012

(54) CONTACTOR FOR AIR CONDITIONING UNIT

(76) Inventor: Donald Nystrom, Oakland Park, FL (US)

(21) Appl. No.: 13/057,107

(22) PCT Filed: Mar. 25, 2010
(86) PCT No.: PCT/US10/28731

§ 371 Date: Feb. 1, 2011

Related U.S. Application Data
(60) Provisional application No. 61/163,400, filed on Mar. 25, 2009.

(51) Int. Cl. H01H 7/00; F25D 17/06; F25B 39/04

(52) U.S. Cl. 62/89; 335/59; 335/67; 62/467

(57) ABSTRACT

A contactor for air conditioning unit includes a first magnetic coil, having a first set of contacts for the compressor; a second magnetic coil, having a second set of contacts for the fan motor; and a time delay device connected in series with either the first magnetic coil or the second magnetic coil. The contactor provides for independent control of the compressor and the fan motor. During the time period when the fan continues running and the compressor is switched off, the device equalizes the pressure difference between different portions of the air conditioning unit.

### RELATED APPLICATIONS

This application claims the benefit of the filing date of U.S. Patent Application No. 61/163,400, filed Mar. 25, 2009, which is incorporated herein by reference in its entirety, and International Patent Application Number PCT/US2010/028731, filed Mar. 25, 2010, which is incorporated herein by reference in its entirety.

### BACKGROUND OF THE INVENTION

The present invention generally relates to electronic circuitry and, more specifically, to a contactor for an air conditioning condensing and package units.

When an existing air conditioning unit is running, one system pressure may very high, and another is much lower. Current time delay devices turn off the entire air conditioning condensing unit. Without a time delay device, should the power stop and then come on again very quickly, the compressor may cycle on a safety device, blow a fuse or trip a circuit breaker switch Current systems turn off everything together, including the compressor and fan motors.

As can be seen, there is a need for a contactor module device for air conditioning condensing units.

### SUMMARY OF THE INVENTION

In one aspect of the present invention, a contactor for an air conditioning unit having a compressor and a fan motor includes a first magnetic coil, having a first set of contacts for the compressor; a second magnetic coil, having a second set of contacts for the fan motor; and a time delay device connected in series with either the first magnetic coil or the second magnetic coil; wherein the contactor provides for independent control of the compressor and the fan motor.

In another aspect of the present invention, a contactor for an air conditioning condensing unit includes a magnetic coil; a time delay device connected in series with the magnetic coil; and a housing containing the magnetic coil and the time delay device; wherein the time delay device prevents the magnetic coil from energizing for a short time period.

In yet another aspect of the present invention, a method of controlling an air conditioning unit having a compressor and fan motor includes utilizing a first magnetic coil to control the compressor; utilizing a time delay device to prevent the first magnetic coil from energizing for a short period of time, thereby switching the compressor off; and utilizing a second magnetic coil to control the fan motor; thereby allowing the fan motor to continue running when the compressor switches off.

### BRIEF DESCRIPTION OF THE DRAWINGS

FIG. 1 depicts a legend utilized in the schematics of FIGS. 2A through 2P;

FIGS. 2A through 2P depict schematics of embodiments of the present invention utilizing two magnetic relay coils, modules “A” through “P”;

FIGS. 3-1 through 3-3 depict embodiments of the present invention utilizing two magnetic relay coils with field wiring;

FIG. 4 depicts a legend utilized in the schematics of FIGS. 5-1 through 5-37;

FIGS. 5-1 through 5-37 depict schematics of embodiments of the present invention utilizing a single magnetic relay coil, modules “1” through “37”; and

FIGS. 6-1 through 6-3 depict embodiments of the present invention utilizing a single relay coil with field wiring.

### DETAILED DESCRIPTION

The preferred embodiment and other embodiments, including the best mode of carrying out the invention, are hereby described in detail with reference to the drawings. Further embodiments, features and advantages will become apparent from the ensuing description or may be learned without undue experimentation. The figures are not drawn to scale, except where otherwise indicated. The following description of embodiments, even if phrased in terms of “the invention,” is not to be taken in a limiting sense, but describes the manner and process of making and using the invention. The coverage of this patent will be described in the claims. The order in which steps are listed in the claims does not indicate that the steps must be performed in that order.

Broadly, an embodiment of the present invention generally is a contactor for an air conditioning condensing unit. A contactor is an electro-magnetic switching device, also called a relay. Embodiment of this contactor may have two magnetic coils. Each magnetic coil may control a separate set of contacts. One of the magnetic coils may have a time delay device in series with the coil. One magnetic coil and set of contacts may be for the condenser fan motor(s), and the other magnetic coil, time delay device and contacts may be for the compressor. During normal conditions, both coils may be energized so the fan and compressor may function together normally.

In the event of a very short power interruption, an embodiment of the invention may not allow the compressor to start until a safe time period has elapsed.

Embodiments of the device may not allow the compressor to come back on until a safe time period has elapsed for the high system pressures to equalize internally, allowing the condenser fan motor to function and helping to reduce the high internal system pressure. Embodiments may allow for independent cycle control of the compressor and fan motor(s), which may allow the compressor to come back on again quickly, and may increase the Seasonal Energy Efficiency Rating (SEER) of the equipment.

Embodiments of the invention may incorporate different air conditioning components into a single device or module. This may save manufacturers assembly time on the production line, require fewer employees on the assembly line, require less warehouse storage space for parts, less transport of parts from the storage area to the assembly line, and may simplify unit wiring.

In an embodiment, in the event of a fault condition, the time delay may activate and prevent the magnetic coil for the compressor from energizing for a short time period. A second coil may energize normally and allow the fan motor or motors to function independently, bringing the high internal system pressure down quickly for a safe and normal compressor start condition.

An embodiment of the invention may turn off the air conditioning compressor only and allows the fan motor(s) to operate independently. This will allow the compressor to come back on much faster and may increase the SEER equipment rating.

One embodiment of the invention includes a single contactor with two magnetic coils, two sets of contacts and one time delay device for one of the coils with its set of contacts. Another embodiment of the invention takes many different components into a single contactor module. This may help reduce manufacturing costs, inventory and warehouse space.

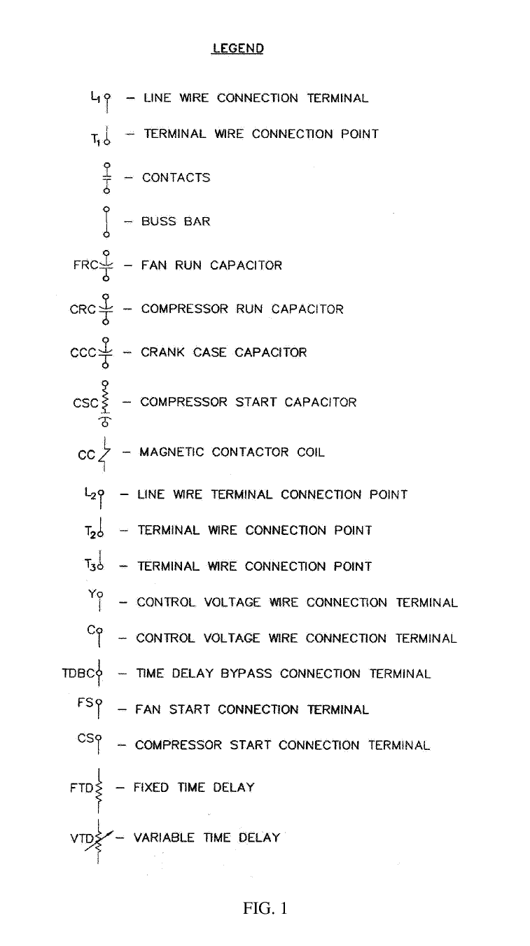

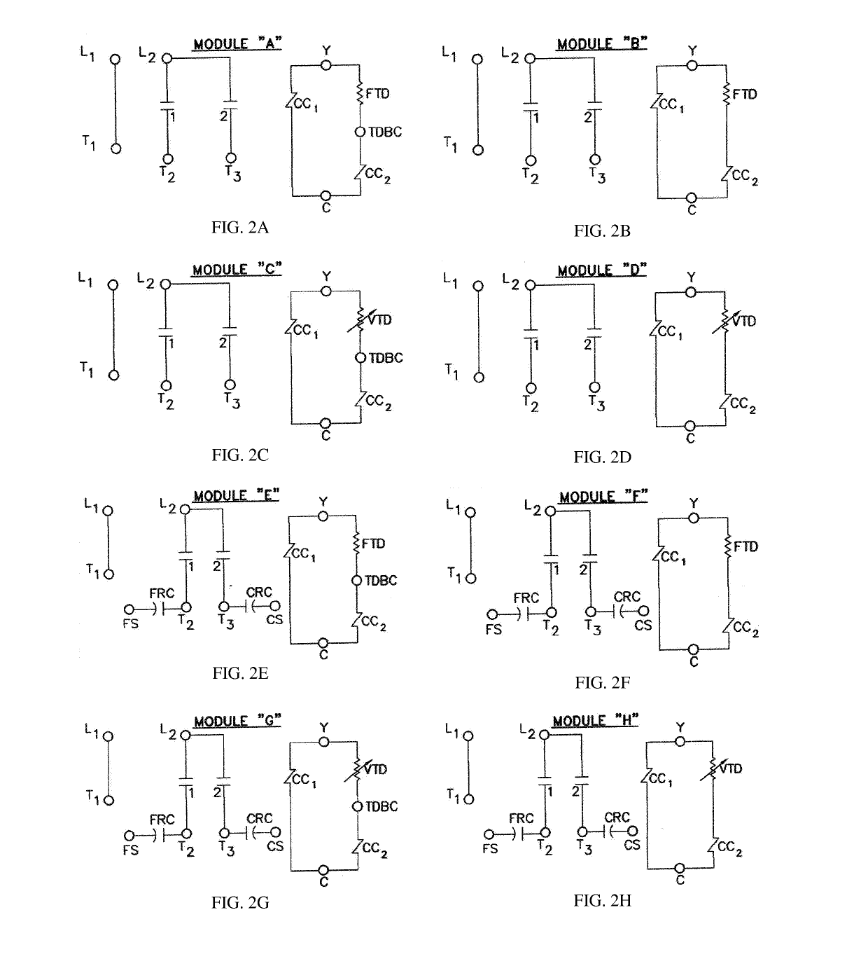

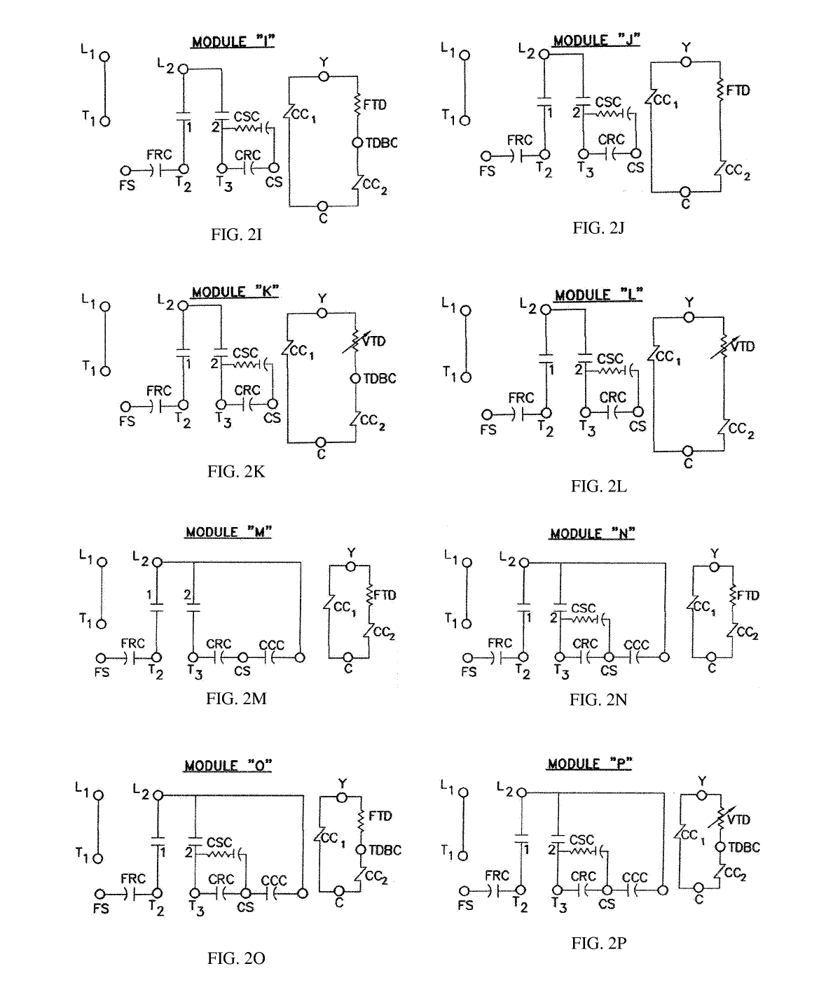

FIG. 1 depicts a legend utilized in FIGS. 2A through 2P, which include schematics of embodiments of circuits utilizing two magnetic relay coils, identified as modules “A” through “P”.

FIG. 2A includes a fixed time delay and time delay bypass connection terminal (TDBC).

FIG. 2B includes a fixed time delay without the TDBC.

FIG. 2C includes a variable time delay and a TDBC.

FIG. 2D includes a variable time delay and no TDBC.

FIG. 2E includes a fixed time delay and TDBC with run capacitors for the compressor and fan motor(s).

FIG. 2F includes a fixed time delay without the TDBC with run capacitors for the compressor and fan motor(s).

FIG. 2G includes a variable time delay and a TDBC with run capacitors for the compressor and fan motor(s).

FIG. 2H includes a variable time delay and no TDBC with run capacitors for the compressor and fan motor(s).

FIG. 21 includes a fixed time delay and TDBC with compressor start capacitor and run capacitors for the compressor and fan motor(s).

FIG. 2J includes a fixed time delay without the TDBC with run capacitors for the compressor and fan motor(s) with compressor start capacitor.

FIG. 2K includes a variable time delay and a TDBC with run capacitors for the compressor and fan motor(s) with compressor start capacitor.

FIG. 2L includes a variable time delay and no TDBC with run capacitors for the compress and fan motor(s) with compressor start capacitor.

FIG. 2M includes a fixed time delay that contains three run capacitors, one for the fan motor, one for the compressor, and one to act as a compressor crank case heater.

FIG. 2N includes a fixed time delay that contains three run capacitors, one for the fan motor, one for the compressor, and one to act as a compressor crank case heater, with compressor start capacitor.

FIG. 20 includes a fixed time delay and a TDBC that contains three run capacitors, one for the fan motor, one for the compressor, and one to act as a compressor crank case heater, with compressor start capacitor.

FIG. 2P includes a variable time delay and a TDBC that contains three run capacitors, one for the fan motor, one for the compressor, and one to act as a compressor crank case heater, with compressor start capacitor.

FIG. 3-1 depicts an embodiment of the present invention, module “A” as depicted in FIG. 2A, connected to a typical field wiring.

FIG. 3-2 depicts an embodiment of the present invention, module “E” as depicted in FIG. 2E, connected to a typical field wiring.

FIG. 3-3 depicts an embodiment of the present invention, module “K” as depicted in FIG. 2K, connected to a typical field wiring.

In the embodiments of FIGS. 3-1, 3-2 and 3-3, each of two coils may control a set of contacts. Embodiments may contain a time delay in series with the coils that controls the contacts for the compressor. Embodiments may contain a time delay by-pass connection terminal.

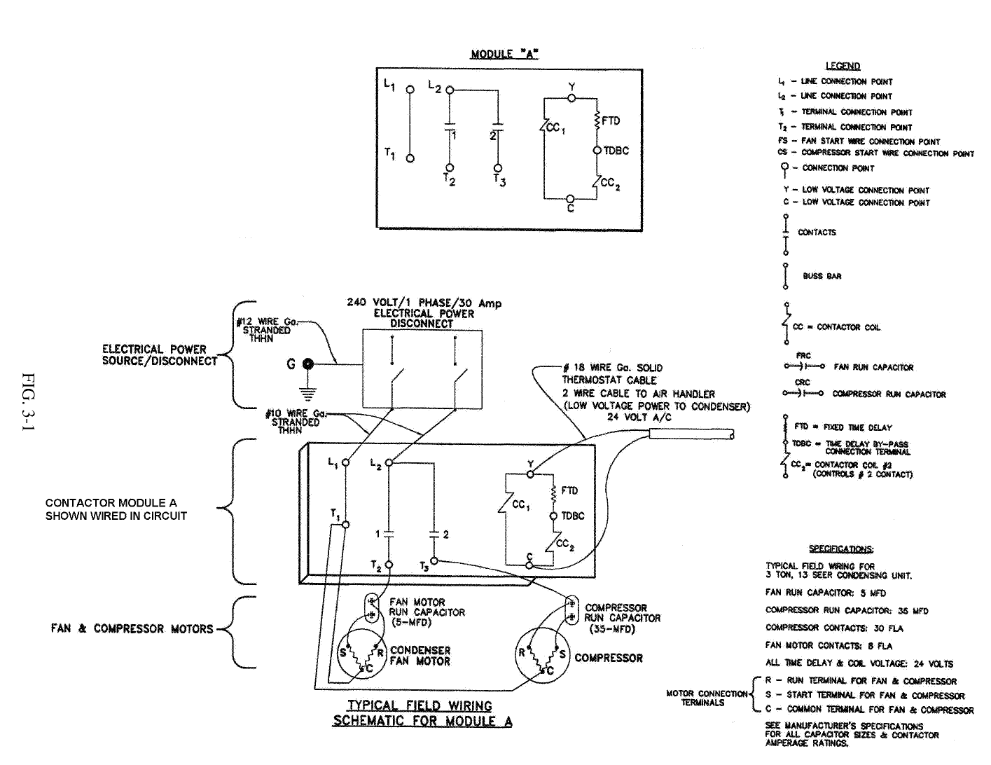

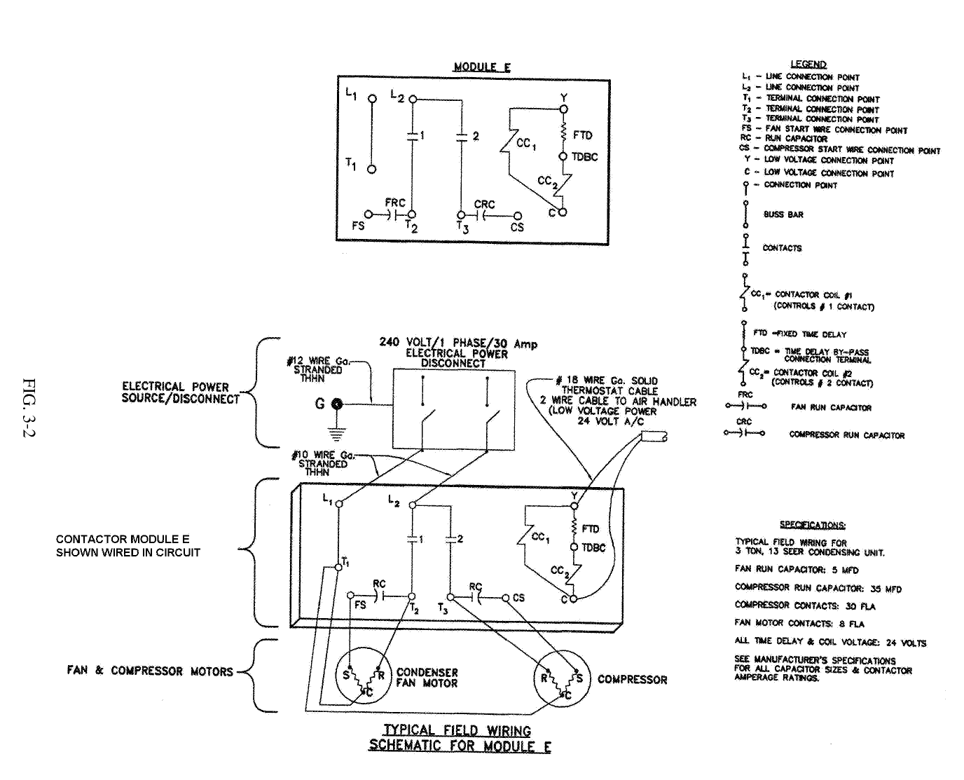

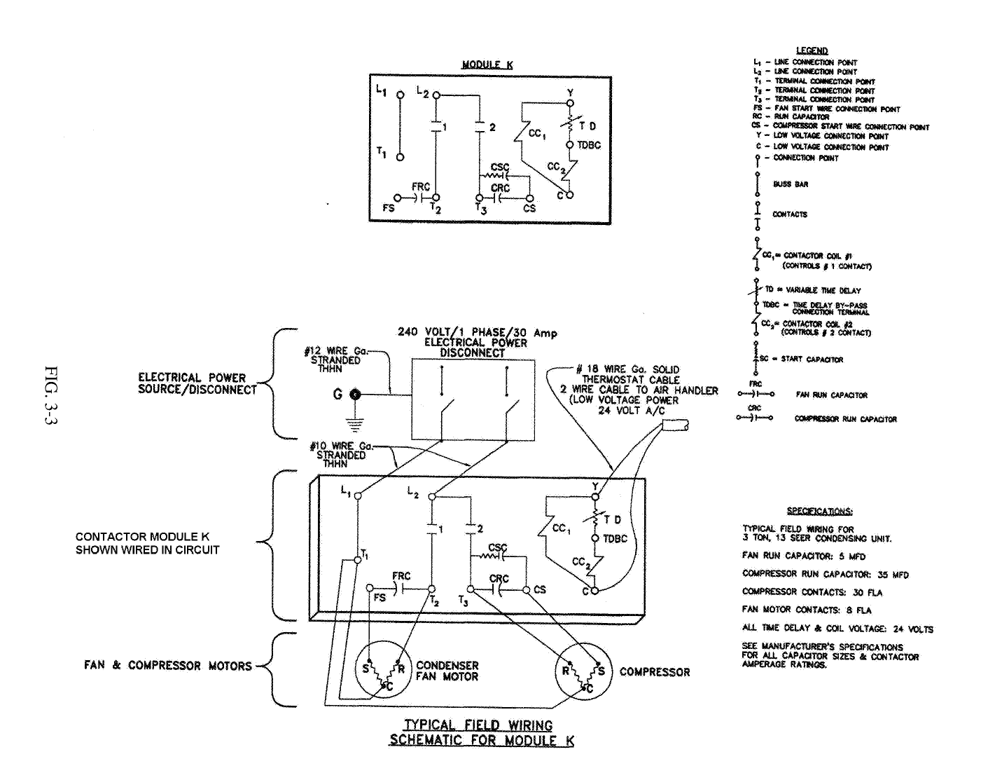

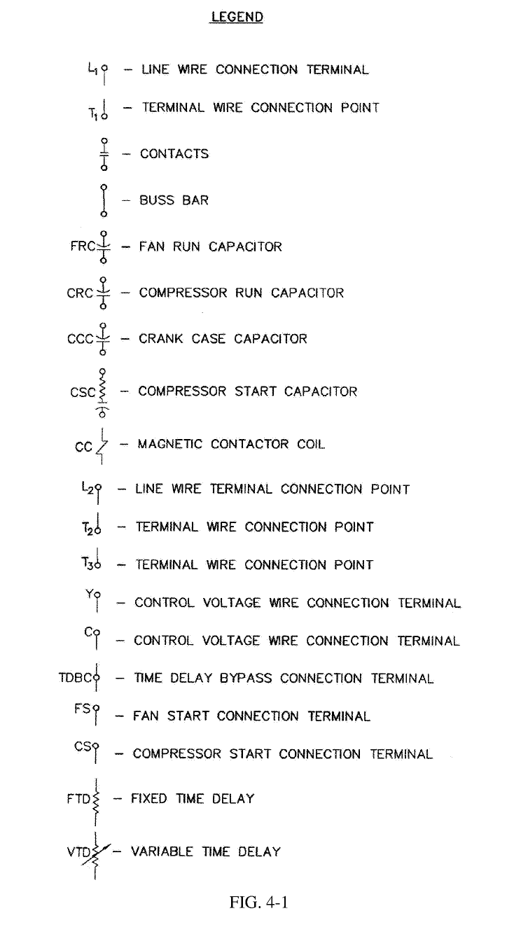

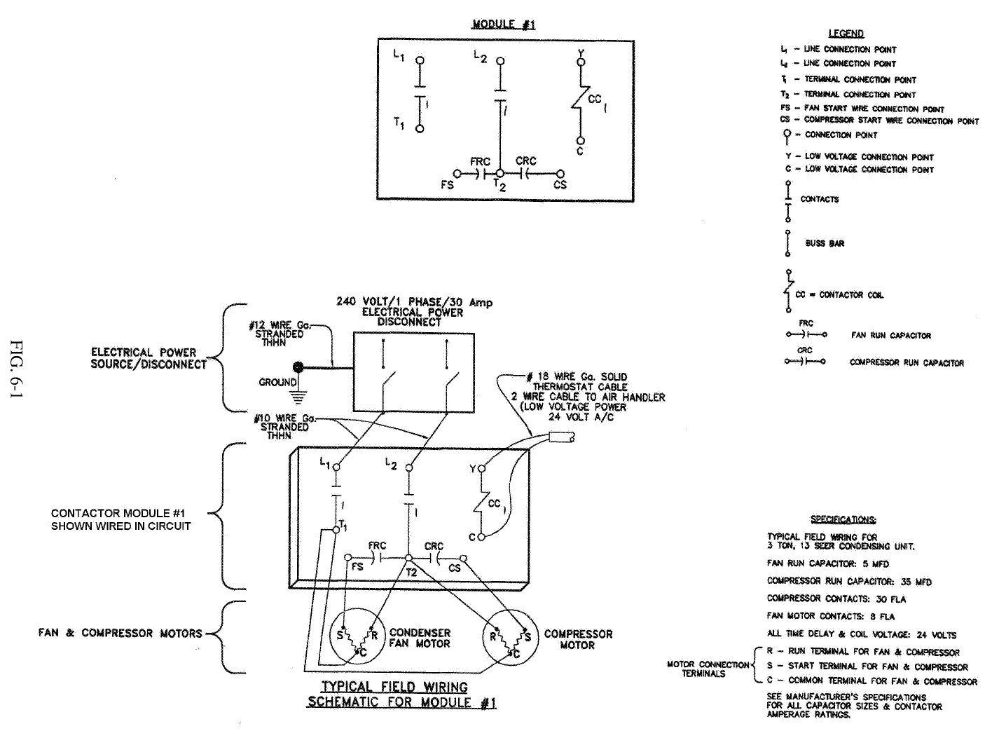

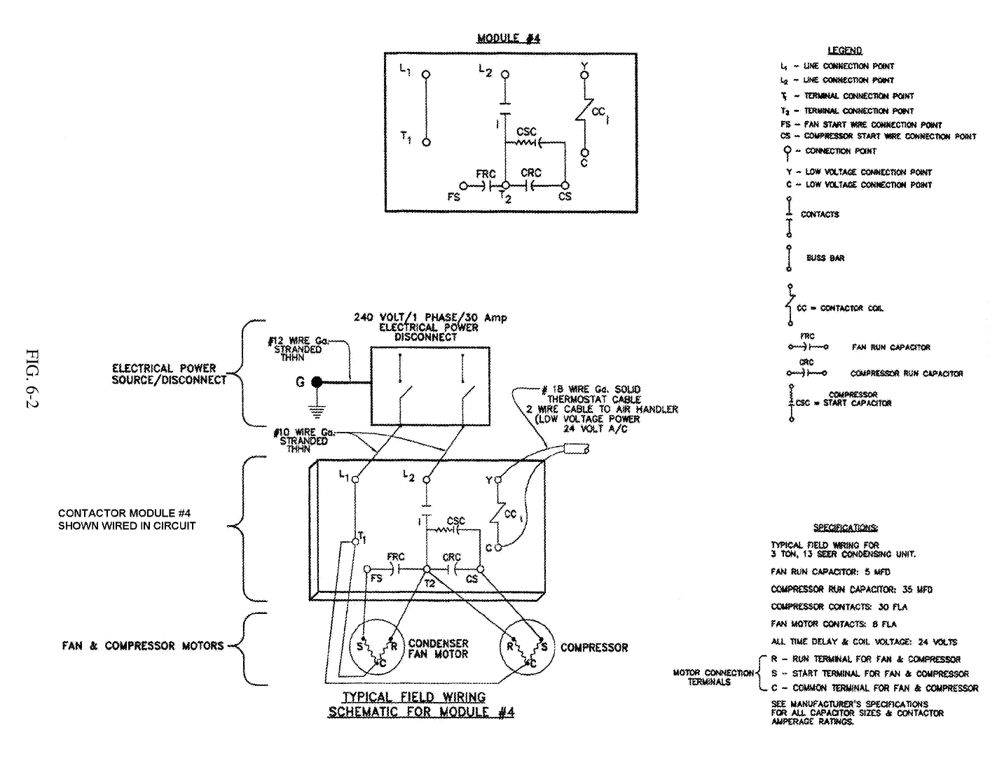

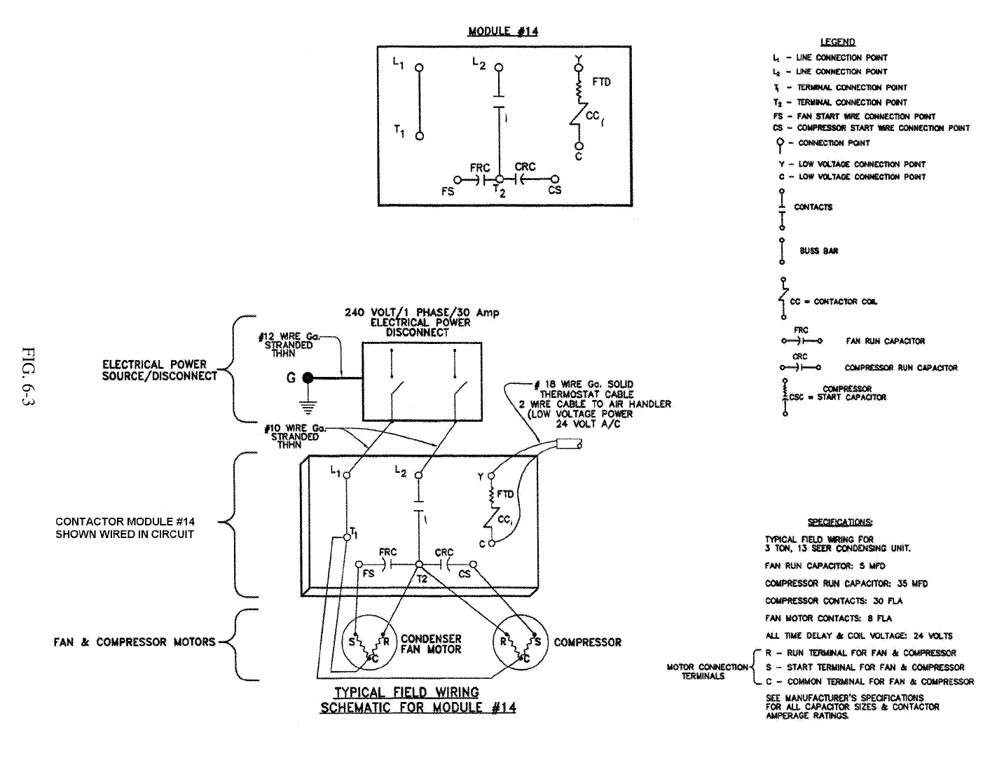

FIG. 4 depicts a legend utilized in FIGS. 5-1 through 5-37, which include schematics of embodiments of circuits utilizing a single magnetic relay coil, identified as modules “1” through “37”.

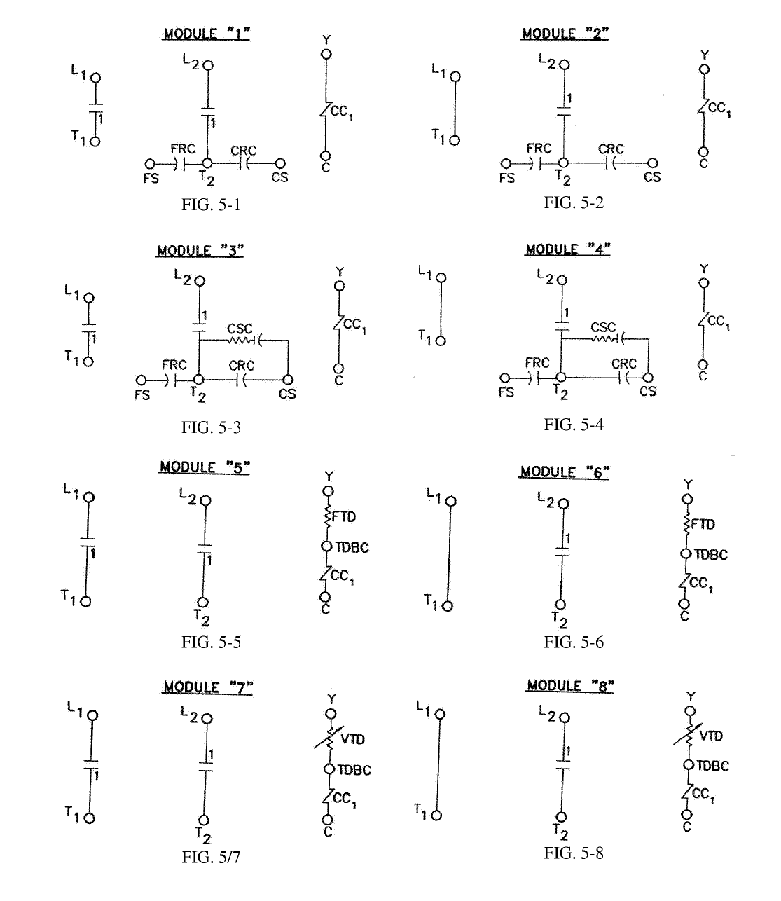

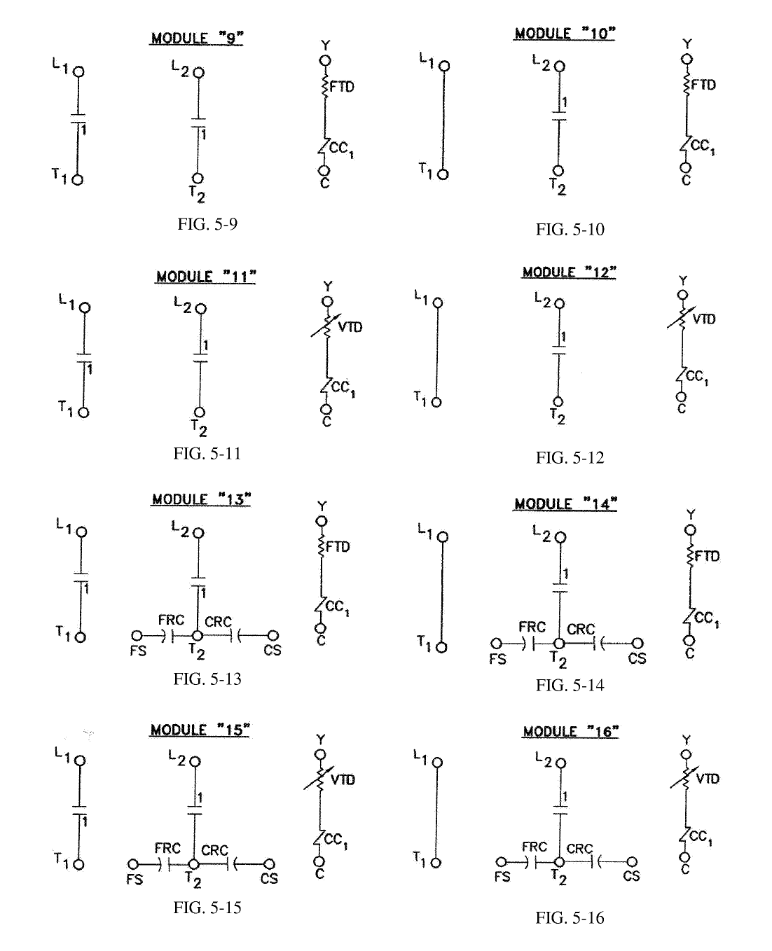

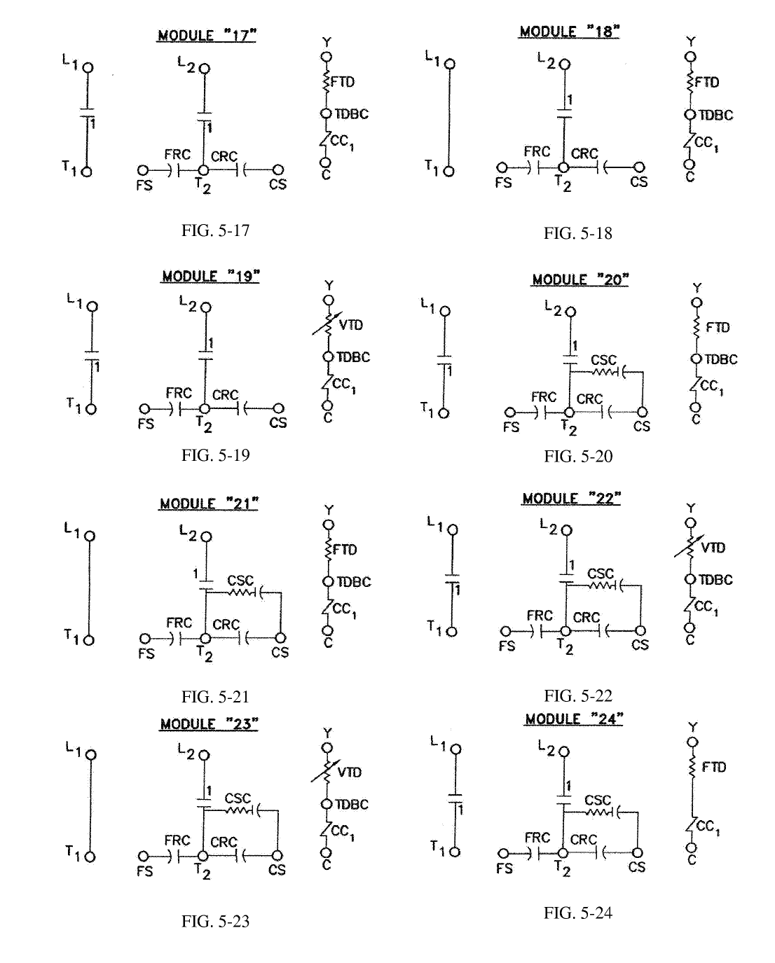

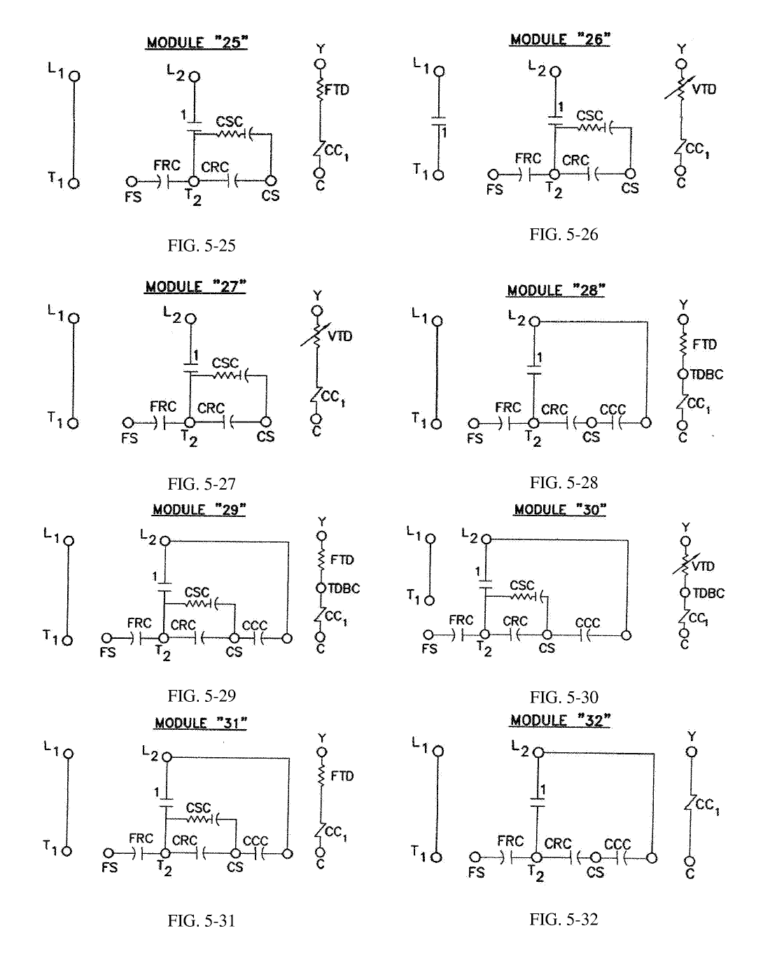

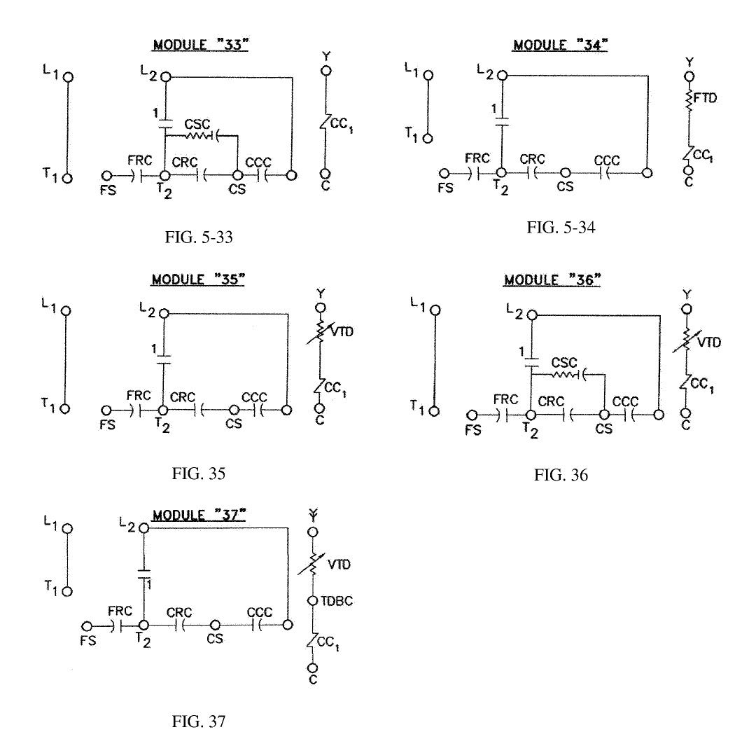

FIG. 5-1 includes internal run capacitors for the compressor and fan motor(s).

FIG. 5-2 includes internal run capacitors for the compressor and fan motor(s) with a buss bar.

FIG. 5-3 includes internal run capacitors for the compressor and fan motor(s) with compressor start capacitor.

FIG. 5-4 includes internal run capacitors for the compressor and fan motor(s) with compressor start capacitor with a buss bar.

FIG. 5-5 includes a fixed time delay with a TDBC.

FIG. 5-6 includes a fixed time delay with a TDBC, a buss bar, and one set of contacts.

FIG. 5-7 includes a variable time delay with a TDBC.

FIG. 5-8 includes a variable time delay with a TDBC, a buss bar, and one set of contacts.

FIG. 5-9 includes a fixed time delay with no TDBC.

FIG. 5-10 includes a fixed time delay, a buss bar, and one set of contacts, with no TDBC.

FIG. 5-11 includes a variable time delay with no TDBC.

FIG. 5-12 includes a variable time delay with a buss bar and one set of contacts, with no TDBC.

FIG. 5-13 includes a fixed time delay with two sets of contacts and no TDBC, with internal run capacitors for the compressor and fan motor(s).

FIG. 5-14 includes a fixed time delay, a buss bar, and one set of contacts, with no TDBC, with internal run capacitors for the compressor and fan motor(s).

FIG. 5-15 includes a variable time delay with two sets of contacts and no TDBC, with internal run capacitors for the compressor and fan motor(s).

FIG. 5-16 includes a variable time delay, a buss bar, and one set of contacts, with no TDBC, with internal run capacitors for the compressor and fan motor(s).

FIG. 5-17 includes a fixed time delay and a TDBC, with two sets of contacts, and internal run capacitors for the compressor and fan motor(s).

FIG. 5-18 includes a fixed time delay and a TDBC, with buss bar and one set of contacts, and internal run capacitors for the compressor and fan motor(s).

FIG. 5-19 includes a variable time delay and a TDBC, with two sets of contacts, and internal run capacitors for the compressor and fan motor(s).

FIG. 5-20 includes a fixed time delay and a TDBC with a compressor start capacitor, and run capacitors for the compressor and fan motor(s), with two sets of contacts.

FIG. 5-21 includes a fixed time delay and a TDBC with a compressor start capacitor, and run capacitors for the compressor and fan motor(s), with a buss bar and one set of contacts.

FIG. 5-22 includes a variable time delay and a TDBC with a compressor start capacitor, and two sets of contacts, with run capacitors for the compressor and fan motor(s).

FIG. 5-23 includes a variable time delay and a TDBC, with one set of contacts, and run capacitors for the compressor and fan motor(s), with a buss bar and compressor start capacitor.

FIG. 5-24 includes a fixed time delay and no TDBC, with a compressor start capacitor, and run capacitors for the compressor and fan motor(s), with two sets of contacts.

FIG. 5-25 includes a fixed time delay and no TDBC, with a compressor start capacitor, and run capacitors for the compressor and fan motor(s), with a buss bar and one set of contacts.

FIG. 5-26 includes a variable time delay and no TDBC, with a compressor start capacitor, and two sets of contacts, and run capacitors for the compressor and fan motor(s).

FIG. 5-27 includes a variable time delay and no TDBC, with run capacitors for the compressor and fan motor(s), a buss bar and one set of contacts with a compressor start capacitor.

FIG. 5-28 includes a fixed time delay and a TDBC, with three run capacitors, one for the fan motor, one for the compressor, and one to act as a compressor crank case heater.

FIG. 5-29 includes a fixed time delay and a TDBC, with three run capacitors, one for the fan motor, one for the compressor, and one to act as a compressor crank case heater, with a buss bar and one set of contacts, with a compressor start capacitor.

FIG. 5-30 includes a variable time delay and a TDBC, with three run capacitors, one for the fan motor, one for the compressor, and one to act as a compressor crank case heater, with a compressor start capacitor, one set of contacts and a buss bar.

FIG. 5-31 includes a fixed time delay and no TDB, with three run capacitors, one for the fan motor, one for the compressor, and one to act as a compressor crank case heater, with a buss bar and one set of contacts.

FIG. 5-32 includes three run capacitors, one for the fan motor, one for the compressor, and one to act as a compressor crank case heater, with a buss bar and one set of contacts.

FIG. 5-33 includes three run capacitors, one for the fan motor, one for the compressor, and one to act as a compressor crank case heater, with a buss bar, one set of contacts, and a compressor start capacitor.

FIG. 5-34 includes a fixed time delay and no TDBC, with three run capacitors, one for the fan motor, one for the compressor, and one to act as a compressor crank case heater, with one set of contacts and a buss bar.

FIG. 5-35 includes a variable time delay and no TDBC, with three run capacitors, one for the fan motor, one for the compressor, and one to act as a compressor crank case heater, with a buss bar and one set of contacts.

FIG. 5-36 includes a variable time delay and no TDBC, with three run capacitors, one for the fan motor, one for the compressor, and one to act as a compressor crank case heater, with a buss bar, one set of contacts, and a compressor start capacitor.

FIG. 5-37 includes a variable time delay with three run capacitors, one for the fan motor, one for the compressor, and one to act as a compressor crank case heater, and a TDBC.

FIG. 6-1 depicts an embodiment of the present invention, module “1” as depicted in FIG. 5-1, connected to a typical field wiring.

FIG. 6-2 depicts an embodiment of the present invention, module “4” as depicted in FIG. 5-4, connected to a typical field wiring.

FIG. 6-3 depicts an embodiment of the present invention, module “14” as depicted in FIG. 5-14, connected to a typical field wiring.

Embodiments may be used by air conditioning equipment manufacturers, and air conditioning service techs. An embodiment of the device could be used for independent motor safety control, such as with compressors, for example, natural gas, air, refrigerants, and other fluids, etc.

It should be understood, of course, that the foregoing relates to exemplary embodiments of the invention and that modifications may be made without departing from the spirit and scope of the invention as set forth in the following claims.

I claim:

1. A contactor for an air conditioning unit having a compressor and a fan motor, the contactor comprising:
a first magnetic coil, having a first set of contacts for the compressor;
a second magnetic coil, having a second set of contacts for the fan motor; and
a time delay device connected in series with either the first magnetic coil or the second magnetic coil;
wherein the contactor provides for independent control of the compressor and the fan motor.

2. The contactor of claim 1, wherein the time delay device is connected in series with the first magnetic coil.

3. The contactor of claim 1, wherein the time delay device is connected in series with the second magnetic coil.

4. The contactor of claim 1, further comprising:
a housing adapted for use in the air conditioning unit, the housing containing the magnetic coils, the contacts, and the time delay device.

5. The contactor of claim 1, wherein the first magnetic coil allows the compressor to function, and the second magnetic coil allows the fan motor to function.

6. The contactor of claim 1, wherein the time delay is variable.

7. The contactor of claim 1, wherein the time delay is fixed.

8. The contactor of claim 1, further comprising a capacitor for the fan motor.

9. The contactor of claim 1, further comprising a capacitor for the compressor.

10. The contactor of claim 1, further comprising:
a first capacitor for the fan motor;
a second capacitor for the compressor; and
a third capacitor to heat a crank case of the compressor.

11. A contactor for an air conditioning condensing unit, comprising:
a magnetic coil;
a time delay device connected in series with the magnetic coil; and
a housing containing the magnetic coil and the time delay device;
wherein the time delay device prevents the magnetic coil from energizing for a short time period.

12. The contactor of claim 11, wherein the magnetic coil allows a compressor of the air conditioning unit to function.

13. The contactor of claim 11, wherein the magnetic coil allows a fan motor of the air conditioning unit to function.

14. The contactor of claim 11, wherein the air conditioning condensing unit has a first portion having a first pressure and a second portion having a second pressure, wherein the first and second pressures equalize during the short time period.

15. The contactor of claim 11, further comprising:
a housing adapted for use in the air conditioning condensing unit, the housing containing the magnetic coils, the contacts, and the time delay device.

16. The contactor of claim 11, further comprising:
a second magnetic coil;
wherein the first magnetic coil allows the compressor to function, and the second magnetic coil allows the fan motor to function, thereby providing independent control of the compressor and the fan motor.

17. The contactor of claim 11, further comprising:
a first capacitor for the fan motor;
a second capacitor for the compressor; and
a third capacitor to heat a crank case of the compressor.

18. A method of controlling an air conditioning unit having a compressor and fan motor, comprising:
utilizing a first magnetic coil to control the compressor;
utilizing a time delay device to prevent the first magnetic coil from energizing for a short period of time, thereby switching the compressor off; and
utilizing a second magnetic coil to control the fan motor;
thereby allowing the fan motor to continue running when the compressor switches off.

19. The method of claim 19, the air conditioning unit having a first portion having a first system pressure and a second portion having a second system pressure, the method further comprising:
during the time period when the fan continues running and the compressor is switched off, equalizing the first system pressure with the second system pressure.
